(19) United States
(12) Patent Application Publication
(10) Pub. No.: US 2026/0059642 A1
(43) Pub. Date: Feb. 26, 2026

(54) Light Source Apparatus

(71) Applicant: USHIO DENKI KABUSHIKI KAISHA, Tokyo (JP)

(72) Inventor: Akihisa NAGANO, Tokyo (JP)

(73) Assignee: USHIO DENKI KABUSHIKI KAISHA, Tokyo (JP)

(21) Appl. No.: 19/298,604

(22) Filed: Aug. 13, 2025

(30) Foreign Application Priority Data
Aug. 23, 2024 (JP) 2024-142334

(51) Int. Cl. H05G 2/00

(52) U.S. Cl. CPC H05G 2/0086; H05G 2/0035

(57) ABSTRACT

According to an embodiment of the present technology, there is provided a light source apparatus that converts a liquid raw material into plasma and extracts radiation by using irradiation with an energy beam, the light source apparatus including: a first member that includes a first region to which the liquid raw material has adhered with a first film thickness; and a beam source that irradiates the first region with the energy beam at a first focusing density and irradiates a first space with the energy beam at a second focusing density, the first space being a space in which the liquid raw material is diffused by the irradiation with the energy beam at the first focusing density, the first focusing density being a focusing density at which the energy beam does not reach the first member when the first region is irradiated with the energy beam.

### CROSS REFERENCE TO RELATED APPLICATIONS

This application claims the benefit of Japanese Priority Patent Application JP 2024-142334 filed Aug. 23, 2024, the entire contents of which are incorporated herein by reference.

### BACKGROUND

The present invention relates to a light source apparatus that generates X-rays, extreme ultraviolet light, and the like.

Extreme ultraviolet light (hereinafter, also referred to as EUV light) among X-rays has been recently used as exposure light. In the base material of an EUV lithography mask, a material that absorbs radiation for EUV lithography is patterned on a multilayer film (e.g., molybdenum and silicon) for reflecting EUV light, so that an EUV mask is formed.

The size of unacceptable defects in EUV masks has become smaller significantly, and the unacceptable defects are difficult to detect. In this regard, EUV masks are inspected using radiation having a wavelength that matches the wavelength operated in lithography, which is called an actinic inspection.

EUV light source apparatuses generally include a discharge produced plasma (DPP) light source apparatus, a laser assisted discharge produced plasma (LDP) light source apparatus, and a laser produced plasma (LPP) light source apparatus.

The DPP light source apparatus applies high voltage between electrodes between which a gaseous plasma raw material (discharge gas) containing EUV radiation species is supplied to generate a high-density, high-temperature plasma by discharge, thereby utilizing the extreme ultraviolet light radiated from the plasma.

The LDP light source apparatus is obtained by improving the DPP light source apparatus. For example, a liquid, high-temperature plasma raw material (e.g., Sn (tin), Li (lithium), etc.) containing EUV radiation species is supplied to the surface of an electrode (discharge electrode) at which discharge is to be generated. The material is then irradiated with a laser beam to be vaporized, and then high-temperature plasma is generated by discharge.

The LPP light source apparatus generates high-temperature plasma by exciting EUV radiation species by a laser beam or the like. As this type of light source apparatuses, a light source apparatus is known, which generates plasma by focusing a laser beam on a droplet of a high-temperature plasma raw material that has been ejected in the form of a minute liquid droplet to excite the target material.

Japanese Patent Application Laid-open No. 2014-216286 proposes a method of supplying a plasma raw material for generating radiation such as X-rays or EUV to a rotating body and irradiating a region in the rotating body, to which the plasma raw material is supplied, with an energy beam (laser beam) to obtain radiation. A cylindrical reservoir with an opening on one side is used as the rotating body, a liquid plasma raw material is supplied to the reservoir, and the inner circumferential surface of the reservoir is irradiated with laser light.

This method corresponds to the so-called LPP method, in which the liquid plasma raw material is supplied to the energy beam irradiation region by centrifugal force of the rotating body, and there is no need to supply the liquid plasma raw material as a droplet. Therefore, it is possible to obtain high-brightness radiation with a relatively simple configuration as compared to the method of focusing a laser beam on a droplet.

### SUMMARY

In the light source apparatus as disclosed in Japanese Patent Application Laid-open No. 2014-216286, there is a need for a technology that makes it possible to achieve a longer service life of a member and to improve the stability of the output power of radiation.

In view of the circumstances as described above, it is desirable to provide a light source apparatus that makes it possible to achieve a longer service life of a member and to improve the stability of the output power of radiation.

According to an embodiment of the present technology, there is provided a light source apparatus that converts a liquid raw material into plasma and extracts radiation by using irradiation with an energy beam, the light source apparatus including a first member and a beam source.

The first member includes a first region to which the liquid raw material has adhered with a first film thickness.

The beam source irradiates the first region with the energy beam at a first focusing density and irradiates a first space with the energy beam at a second focusing density, the first space being a space in which the liquid raw material is diffused by the irradiation with the energy beam at the first focusing density.

The first focusing density is a focusing density at which the energy beam does not reach the first member when the first region is irradiated with the energy beam.

In such a light source apparatus, the region to which the liquid raw material has adhered with a predetermined film thickness is irradiated with the energy beam at the first focusing density, and the space in which the liquid raw material is thus diffused is irradiated with the energy beam at the second focusing density. The first focusing density is a focusing density at which the energy beam does not reach the first member by the irradiation on the first region. This makes it possible to suppress damage to the first member, achieve a longer service life of the first member, and improve the stability of the output power of the radiation. Here, “the focusing density at which the energy beam does not reach the first member” is a focusing density that does not cause traces such as beam traces or damage to the first member due to the irradiation with the energy beam, and varies depending on the size of the film thickness of the liquid raw material that adheres to the first region.

The beam source may a second region, to which the liquid raw material has adhered with a second film thickness, with the energy beam at a third focusing density, the second region being different from the first region, and may irradiate a space that is a common part of the first space and a second space with the energy beam at the second focusing density, the second space being a space in which the liquid raw material is diffused by the irradiation with the energy beam at the third focusing density. In this case, the third focusing density may be a focusing density at which the energy beam does not reach a second member when the second region is irradiated with the energy beam.

The light source apparatus may further include the second member that is different from the first member and includes the second region.

The first member may be a disk-shaped rotating body.

The first member and the second member may be disk-shaped rotating bodies.

The first region may be located on a circular surface of the first member. In this case, the second region may be located on a circular surface of the second member.

The first region may be located on a side surface of the first member. In this case, the second region may be located on a side surface of the second member.

The beam source may emit the energy beam of the first focusing density and the energy beam of the third focusing density such that the energy beam of the first focusing density and the energy beam of the third focusing density intersect with each other.

The beam source may emit the energy beam of the first focusing density and the energy beam of the third focusing density such that the energy beam of the first focusing density and the energy beam of the third focusing density do not intersect with each other.

Each of the first member and the second member may be capable of rotating with a common shaft member as a rotation axis.

The beam source may apply each of the energy beam of the first focusing density and the energy beam of the second focusing density as a pulse wave. In this case, the beam source may alternately apply the energy beam of the first focusing density and the energy beam of the second focusing density one time each.

The energy beam applied at the second focusing density may have a pulse width of 10 ns or less and may have a pulse energy of 0.005 J or more, and
if the pulse energy is 0.005 J or more and less than 0.02 J, a spot size that is a diameter of a portion at which an intensity of the energy beam is 1/e-times a peak value may be 100 μm or less when e is assumed to be a natural logarithm,
if the pulse energy is 0.02 J or more and less than 0.05 J, the spot size may be 200 μm or less,
if the pulse energy is 0.05 J or more and less than 0.15 J, the spot size may be 300 μm or less, and
if the pulse energy is 0.15 J or more, the spot size may be 600 μm or less.

The energy beam applied at the second focusing density may have a pulse width of 10 ns or less and may have a pulse energy of 0.15 J or more, and the spot size may be 600 μm or less, or
the energy beam applied at the second focusing density may have a pulse width of 10 ns or less and may have a pulse energy of 0.005 J or more, and the spot size may be 100 μm or less.

The light source apparatus may further include an emission chamber disposed on an emission axis of the radiation. In this case, the first member may be disposed such that the first region does not face the emission chamber.

According to the present invention, it is possible to improve the stability of the output power of the radiation. Note that the effects described herein are not necessarily limitative, and any effect described in the present disclosure may be provided.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic diagram showing a configuration example of a light source apparatus according to an embodiment;

FIG. 2A is a schematic diagram showing a configuration example of a plasma generation mechanism;

FIG. 2B is a schematic diagram showing a configuration example of the plasma generation mechanism;

FIG. 3 is a schematic diagram showing a variation example of a rotating body;

FIG. 4 is a schematic diagram showing a variation example of the rotating body;

FIG. 5A is a schematic diagram showing a variation example of the rotating body;

FIG. 5B is a schematic diagram showing a variation example of the rotating body;

FIG. 6A is a table showing conditions of an energy beam EB2;

FIG. 6B is a table showing conditions of the energy beam EB2;

FIG. 6C is a table showing conditions of the energy beam EB2;

FIG. 6D is a table showing conditions of the energy beam EB2;

FIG. 7 is a schematic diagram showing a configuration example of a single rotating body including two regions; and

FIG. 8 is a schematic diagram showing a configuration example in which a rotating body disposed as a first member and a rotating body disposed as a second member function as a debris mitigation mechanism.

### DETAILED DESCRIPTION OF EMBODIMENTS

### First Embodiment

Hereinafter, a first embodiment according to the present invention will be described with reference to the drawings.

### [Basic Configuration of Light Source Apparatus]

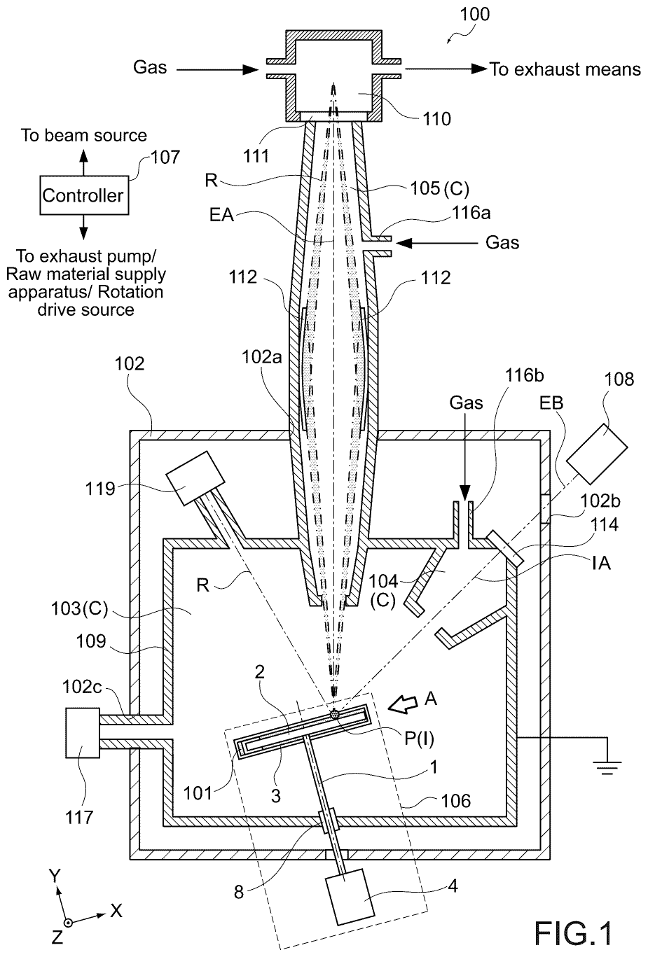

FIG. 1 is a schematic diagram showing a configuration example of a light source apparatus 100 according to this embodiment. The light source apparatus 100 is a laser produced plasma (LPP) light source apparatus. In other words, the light source apparatus 100 is an apparatus that irradiates a plasma raw material 101 with an energy beam EB to excite the plasma raw material 101 and generate plasma P, and then extracts radiation R emitted from the plasma P to use the radiation R as a light source. The radiation R is extreme ultraviolet (EUV) light, X-rays, or other electromagnetic waves.

The plasma raw material 101 is a molten metal or alloy, such as tin (Sn), lithium (Li), gadolinium (Gd), terbium (Tb), gallium (Ga), bismuth (Bi), or indium (In) in the liquid phase or an alloy containing at least one of those materials.

The plasma raw material 101 corresponds to one embodiment of a liquid raw material.

FIG. 1 is a diagram of a schematic cross section of the light source apparatus 100 taken along the horizontal direction at a predetermined height position from its installation surface as viewed vertically from above. In FIG. 1, in order to facilitate the understanding of the configuration and operation of the light source apparatus 100, the illustration of the cross sections is omitted for the portions whose cross-sectional configurations or the like do not need to be described. Hereinafter, description may be given assuming that the X-direction denotes the left-right direction (the positive side of the X-axis is the right side, and the negative side thereof is the left side) in the horizontal direction, the Y-direction denotes the front-rear direction (the positive side of the Y-axis is the front side, and the negative side thereof is the rear side) in the horizontal direction, and the Z-direction denotes the vertical direction (the positive side of the Z-axis is the upper side, and the negative side thereof is the lower side). Of course, when the present technology is applied, the orientations in which the light source apparatus 100 is used, and the like are not limited.

As shown in FIG. 1, the light source apparatus 100 includes an enclosure 102, a vacuum chamber 103, an energy beam incident chamber 104, a radiation emission chamber 105, a plasma generation mechanism 106, a controller 107, and a beam source 108.

In the example shown in FIG. 1, the enclosure 102 includes an emission hole 102a, an incidence hole 102b, and a through-hole 102c. In this embodiment, an emission axis EA of the radiation R is set to pass through the emission hole 102a. The radiation R is extracted along the emission axis EA and emitted from the emission hole 102a. In addition, in this embodiment, an incidence axis IA of the energy beam EB is set to pass through the incidence hole 102b.

As shown in FIG. 1, the beam source 108 that emits the energy beam EB is installed outside the enclosure 102. The beam source 108 is installed to allow the energy beam EB to enter the enclosure 102 along the incidence axis IA. An electron beam or laser light can be used as the energy beam EB.

The light source apparatus 100 is provided with a chamber section C including a plurality of chambers. Specifically, the chamber section C includes the vacuum chamber 103, the energy beam incident chamber (hereinafter, simply referred to as incident chamber) 104, and the radiation emission chamber (hereinafter, simply referred to as emission chamber) 105. The vacuum chamber 103 and the incident chamber 104 are coupled to each other, and the vacuum chamber 103 and the emission chamber 105 are coupled to each other.

The incident chamber 104 is configured to be located on the incidence axis IA of the energy beam EB, and the emission chamber 105 is configured to be located on the emission axis EA of the radiation R. A collector (focusing mirror) 112 that guides the radiation R is disposed inside the emission chamber 105. In addition, the plasma generation mechanism 106 that generates plasma P is disposed in the vacuum chamber 103.

A utilization apparatus such as a mask inspection apparatus is connected to an end portion of the emission chamber 105 on the side opposite to the plasma generation mechanism 106. In the example shown in FIG. 1, an application chamber 110 is connected as a chamber constituting part of the utilization apparatus. The pressure inside the application chamber 110 may be an atmospheric pressure. In addition, the inside of the application chamber 110 may be purged by introducing gas (e.g., inert gas) through a gas inlet passage, if necessary, and then exhausted by exhaust means (not shown). A filter film 111 and an opening that physically separate a region in which the plasma P is generated from the application chamber 110 are provided between the application chamber 110 and the emission chamber 105.

A chamber main body 109 is provided with an incident window 114. The incident window 114 is disposed at a position aligned with the incidence hole 102b on the incidence axis IA of the energy beam EB. In addition, an exhaust pump 117 is connected to the chamber main body 109.

In addition, as shown in FIG. 1, the emission chamber 105 and the incident chamber 104 are provided with gas inlet passages 116a and 116b, respectively, and gas is supplied to the inside of the emission chamber 105 and the incident chamber 104 from a gas supply apparatus (not shown). A gas with high transmittance to the radiation R, such as argon or helium, is supplied to the emission chamber 105. In addition, a gas with high transmittance to the energy beam EB, such as argon or helium, is supplied to the incident chamber 104.

The plasma generation mechanism 106 is a mechanism for generating the plasma P in the vacuum chamber 103 and emitting the radiation R (X-rays or EUV light). As shown in FIG. 1, the plasma generation mechanism 106 includes a rotating body 2, on which the energy beam EB is incident. The rotating body 2 is disposed within the vacuum chamber 103 such that an irradiation position I of the energy beam EB is located at an intersection between the incidence axis IA and the emission axis EA.

The controller 107 controls the operation of each component of the light source apparatus 100. For example, the controller 107 controls the operations of the beam source 108 and the exhaust pump 117. In FIG. 1, the controller 107 is schematically illustrated as a functional block, but the position at which the controller 107 is provided, and the like may be discretionally designed.

In addition, as shown in FIG. 1, in this embodiment, a radiation diagnostic section 119 is connected to the chamber main body 109. The radiation diagnostic section 119 is disposed at a position on which the radiation R emitted in a direction different from the emission axis EA of the radiation R is incident. The radiation diagnostic section 119 measures the state of the radiation R emitted from the plasma P.

### [Plasma Generation Mechanism]

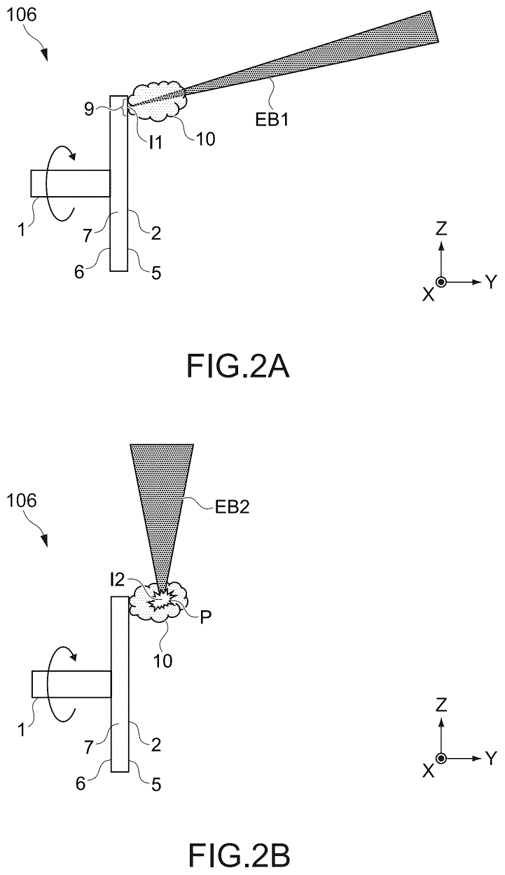

FIGS. 2A and 2B are schematic diagrams each showing a configuration example of the plasma generation mechanism 106.

FIGS. 2A and 2B show the state of the plasma generation mechanism 106 shown in FIG. 1 as viewed from the direction of the arrow A. The plasma generation mechanism 106 includes a shaft member 1, a rotating body 2, a raw material container 3, and a motor 4. Of those, only the shaft member 1 and the rotating body 2 are shown in FIGS. 2A and 2B, and the illustration of the raw material container 3 and the motor 4 is omitted.

The shaft member 1 is a rod-shaped member, and as shown in FIG. 1, disposed parallel to the Y-direction so as to penetrate the enclosure 102 and the vacuum chamber 103. In this example, a mechanical seal 8 or the like is provided at a portion at which the vacuum chamber 103 is penetrated, which allows the shaft member 1 to rotate while maintaining the airtightness of the vacuum chamber 103.

The rotating body 2 is a disk-shaped member and has circular front surface 5 and back surface 6 and a side surface 7. The rotating body 2 is disposed inside the vacuum chamber 103 such that the center of the back surface 6 is connected to an end portion of the shaft member 1 on the side of the vacuum chamber 103. The rotating body 2 is disposed perpendicular to the shaft member 1, that is, disposed parallel to the XZ plane. The rotating body 2 is made of a material having, for example, corrosion resistance to the plasma raw material 101 and a certain level of rigidity.

The rotating body 2 corresponds to one embodiment of a first member according to the present technology.

The raw material container 3 is disposed to cover the lower part of the rotating body 2. The specific form of the raw material container 3 is not limited and may have any form that can cover the lower part of the rotating body 2. The liquid plasma raw material 101 is accumulated in the raw material container 3, and thus the lower part of the rotating body 2 is immersed in the plasma raw material 101.

For example, the plasma raw material 101 is supplied to the raw material container 3 by a raw material supply mechanism (not shown) and is heated and melted by a heater or the like provided to the raw material container 3, so that the liquid plasma raw material 101 is accumulated.

The motor 4 is disposed outside the enclosure 102 so as to be connected to an end portion of the shaft member 1 on the outside of the enclosure 102. The specific type of motor 4 is not limited.

### [Operation of Light Source Apparatus]

The operation of the light source apparatus 100 will be described. The controller 107 controls the motor 4 to be driven, so that the shaft member 1 and the rotating body 2 integrally rotate. FIGS. 2A and 2B each show the rotation direction of the shaft member 1 and the rotating body 2 by the arrow. In this example, the shaft member 1 and the rotating body 2 rotate clockwise as viewed from the front in the Y-axis, but may also rotate counterclockwise. In addition, the specific rotation speed is not limited.

Since the lower part of the rotating body 2 is immersed in the liquid plasma raw material 101, when the rotating body 2 rotates, the plasma raw material 101 is lifted while adhering to the surfaces of the rotating body 2 (front surface 5, back surface 6, and side surface 7). Therefore, the plasma raw material 101 adheres to portions that are not immersed in the plasma raw material 101 in the surfaces of the rotating body 2.

In this embodiment, irradiation with an energy beam EB1 shown in FIG. 2A and irradiation with an energy beam EB2 shown in FIG. 2B are performed under the above state. The energy beams EB1 and EB2 have different focusing densities. Hereinafter, the focusing densities of the energy beams EB1 and EB2 are referred to as a “first focusing density” and a “second focusing density”, respectively, in some cases. In addition, each of the energy beams EB1 and EB2 is applied as a pulse wave.

In this example, two beam sources 108 are used, one of which applies the energy beam EB1 and the other one of which applies the energy beam EB2. Note that FIGS. 2A and 2B omit the illustration of the two beam sources 108. FIG. 1 schematically shows the two beam sources 108 as a single beam source 108 and the two energy beams EB1 and EB2 as a single energy beam EB collectively.

The present invention is not limited to the above case, and the energy beams EB1 and EB2 having different focusing densities may also be applied by a single beam source 108. Specifically, an optical system may be provided between the beam source 108 and the rotating body 2 to separate a single energy beam EB into two energy beams EB1 and EB2 having different focusing densities.

In the example shown in FIG. 2A, the plasma raw material 101 has adhered to a region 9 with a predetermined film thickness, the region 9 being located on the upper part of the front surface 5 of the rotating body 2, and the energy beam EB1 is obliquely applied to an inward position of the region 9. An irradiation position I1 may be an inward position of the region 9 or may also be a region having a certain range included in the region 9. The present invention is not limited to the above, and irradiation may be performed on any region of the front surface 5, which is not immersed in the plasma raw material 101.

The region 9 corresponds to one embodiment of a first region according to the present technology.

The film thickness of the region 9 corresponds to one embodiment of a first film thickness according to the present technology.

When the energy beam EB1 is applied, the plasma raw material 101 adhering at the irradiation position I1 diffuses (or evaporates). FIGS. 2A and 2B schematically show a diffusion space 10 that is the space in which the plasma raw material 101 has diffused. In this example, since the plasma raw material 101 diffuses toward the right in the figure relative to the irradiation position I1, the diffusion space 10 is also located on the right relative to the rotating body 2.

The diffusion space 10 corresponds to one embodiment of a first space according to the present technology.

Next, as shown in FIG. 2B, the energy beam EB2 is applied to the diffusion space 10 from the upper side in the figure. At an irradiation position 12, the energy beam EB2 is absorbed by the plasma raw material 101 diffused in the diffusion space 10, and plasma P is generated. The radiation R shown in FIG. 1 is then generated. Note that the illustration of the radiation R is omitted in FIG. 2B.

The operations shown in FIGS. 2A and 2B are alternately repeated to thereby generate the radiation R. In other words, the energy beams EB1 and EB2 serving as pulse waves are alternately applied one time each, so that the following situation is maintained; the diffusion space 10 is constantly generated, and the plasma P and the radiation R are generated in the diffusion space 10.

Meanwhile, to the extent that the present technology is feasible, irradiation in which the energy beam EB1 is applied twice and the energy beam EB2 is then applied once, or irregular irradiation may be performed, for example. In addition, the specific irradiation angles and the like of the energy beams EB1 and EB2 are not limited.

### [Focusing Density and Film Thickness]

In the present technology, the first focusing density of the energy beam EB1 is set as a focusing density at which the energy beam EB1 does not reach the rotating body 2 when the energy beam EB1 is applied to the region 9. In other words, at the irradiation position I1 of FIG. 2A, the energy beam EB1 reaches the surface and inside of the film of the plasma raw material 101, but it does not reach the front surface 5 of the rotating body 2. If the energy beam EB1 reaches the front surface 5 of the rotating body 2, traces such as discoloration and change in surface shape, which are different at a position to which the energy beam EB1 has not applied, are left at the position to which the energy beam EB1 has applied on the front surface 5 of the rotating body 2. Therefore, if no discoloration or change in surface shape is observed at the position to which the energy beam EB1 has applied on the front surface 5 of the rotating body 2, it can be easily determined that the first focusing density is a focusing density at which the energy beam EB1 does not reach the rotating body 2.

On the other hand, the second focusing density of the energy beam EB2 may be set to be large enough to obtain radiation R of a desired intensity. For example, the second focusing density may be larger than the first focusing density of the energy beam EB1. In addition, the second focusing density may also be a focusing density at which the energy beam EB2 reaches the rotating body 2 when the energy beam EB2 is applied to the region 9. In other words, actually, the energy beam EB2 is not directly applied to the rotating body 2, but if it is assumed that the energy beam EB2 is directly applied, the second focusing density may be a focusing density at which the energy beam EB2 reaches the surface and the inside of the film of the plasma raw material 101 and further reaches the front surface 5 of the rotating body 2. In this case, the first focusing density has a value at which the energy beam fails to reach the front surface 5 and causes no traces of the energy beam on the front surface 5, and the second focusing density has a value at which the energy beam can reach the front surface 5 and causes traces of the energy beam on the front surface 5, so that the second focusing density is naturally larger than the first focusing density.

Conversely, the second focusing density may be a focusing density at which the energy beam EB2 does not reach the rotating body 2 when the energy beam EB2 is applied to the region 9. In this case, the second focusing density may be larger or smaller than the first focusing density.

Such settings of the first focusing density and the second focusing density are performed while considering the film thickness or the like of the region 9. Specifically, changing the output power of the energy beam EB or changing a focal distance by a lens makes it possible to change the focusing density. In addition, in order to adjust the film thickness adhering to the rotating body 2, recesses may be formed in the first region of the rotating body 2. Forming the recesses makes it possible to adjust to a large extent the film thickness of the plasma raw material 101 to adhere, thereby providing a configuration that makes it difficult for the energy beam EB1 to reach the front surface 5 of the rotating body.

In addition, if there is a desired size or shape of the diffusion space 10, the first focusing density may be set in consideration of those size and shape. For example, increasing the first focusing density makes it possible to increase the volume of the diffusion space 10. In addition, if there is a desired intensity of the radiation R, the second focusing density may be set in consideration of that intensity. Other specific values of the first focusing density and second focusing density and their setting criteria may be discretionally set.

Additionally, in this example, the film thickness of the plasma raw material 101 in the region 9 is adjusted by arranging a skimmer (not shown) on the rotating body 2. In addition, the film thickness also depends on the type of plasma raw material 101, the rotation speed of the rotating body 2, and the like.

Hereinabove, in the light source apparatus 100 according to this embodiment, the energy beam EB1 is applied at the first focusing density to the region 9 in which the plasma raw material 101 has adhered with a predetermined film thickness, and the energy beam EB2 is applied to the diffusion space 10 at the second focusing density. The first focusing density is a focusing density at which the energy beam EB1 does not reach the rotating body 2 by the irradiation on the region 9. This makes it possible to suppress damage to the rotating body 2, achieve a longer service life of the rotating body 2, and improve the stability of the output power of the radiation R.

Regardless of use applications such as an inspection, light sources constantly need to increase the output power in order to improve the performance of devices using the light sources. This is also true for EUV light sources. In order to increase the output power of the EUV light, the LPP method using a rotating body needs to generate plasma by supplying the minimum amount of liquid metal required to suppress the amount of generation of debris while heating them with a high intensity laser.

As long as the energy conversion efficiency from laser to EUV is maintained, as the laser power is increased, more EUV energy can be extracted. However, as the laser power is increased, the load on the base material increases, which causes deformation such as depression on the surface of the base material. This makes is difficult to perform stable and continuous emission of EUV light.

In addition, although the molten raw material (target) is irradiated with laser, the density distribution of the target is difficult to control by simply applying the laser, and the laser is not efficiently absorbed by the plasma because the wavelength of the laser is not matched with the critical density. Therefore, the output power of EUV light becomes unstable.

On the other hand, a method that does not use a base material, for example, a method of directly irradiating the raw material of droplets with laser is also conceivable, but it is very difficult to adjust the irradiation position because it must be adjusted at the level of several micrometers to several tens of micrometers.

In the present technology, the first focusing density of the energy beam EB1 applied to the rotating body 2 is set as a focusing density at which the energy beam EB1 does not reach the rotating body 2, and thus the load exerted by the energy beam EB1 on the rotating body 2 can be suppressed to a large extent. Use of the method of the present technology makes it possible to prevent deformation of the rotating body 2 and to stabilize the output power of the radiation R.

In addition, the main energy beam EB2 is applied to the diffusion space 10. The plasma raw material 101 diffused in the diffusion space 10 changes into a vapor or a weakly ionized plasma-like state, and thus when it reaches a target density that matches the wavelength of the energy beam EB2 and is then irradiated with the energy beam EB2, the energy beam EB2 is satisfactorily absorbed, so that the plasma P can be generated. This makes it possible to maintain a light-emitting efficiency while applying the energy beam EB2 to a location spaced away from the rotating body 2.

In addition, since the film of the plasma raw material 101 that has adhered to the rotating body 2 is rotating, even if the plasma raw material 101 is diffused by the irradiation with the energy beam EB1 and the surface of the film is depressed, a smooth surface immediately appears again at the irradiation position I1 due to the rotation, so that a smooth surface is constantly irradiated with the energy beam EB1. Therefore, the plasma raw material 101 constantly diffuses in the same way, and the shape of the diffusion space 10 is also constantly the same. In addition, the irradiation position 12 is only about 0.5 cm or less away from the irradiation position I1. This makes it easy to adjust the irradiation position 12.

In addition, in the present technology, the energy beams EB1 and EB2 are applied as pulse waves, respectively, and are alternately applied one time each. This prevents a situation in which the plasma raw material 101 is not diffused at the irradiation position 12, and makes it possible to stabilize the output power of the radiation R.

### Second Embodiment

A more detailed embodiment of the light source apparatus 100 according to the present technology will be described as a second embodiment. In the following description, the description of the parts similar to the configurations and actions of the light source apparatus 100 described in the above embodiment will be omitted or simplified.

### [Variations of Rotating Body]

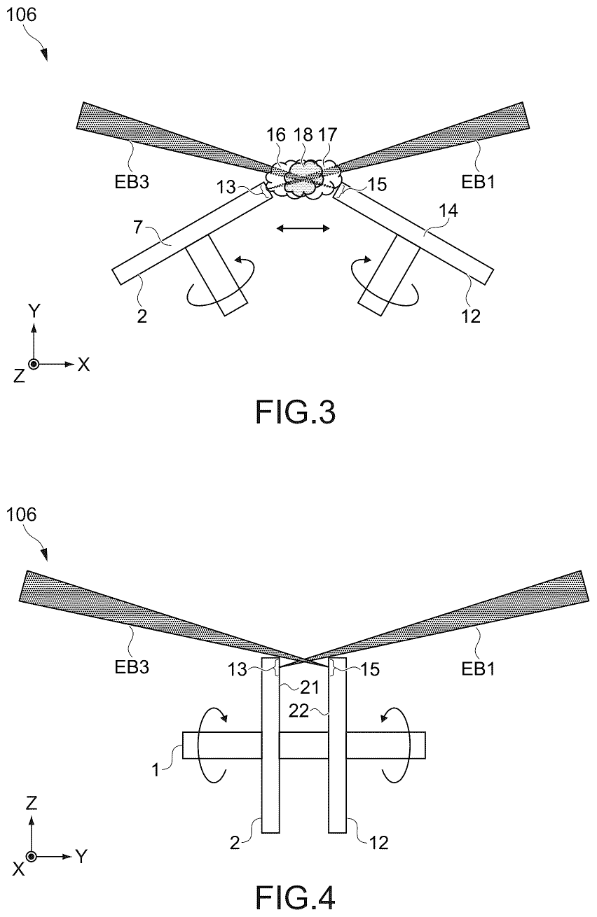

FIG. 3 is a schematic diagram showing a variation example of the rotating body 2.

In this embodiment, in addition to the rotating body 2 shown in FIGS. 2A and 2B, another rotating body 12 is used. The rotating body 12 is a disk-shaped rotating body having a configuration similar to that of the rotating body 2. In this example, as viewed from the front of the Z-axis, the rotating body 2 is disposed on the left side, and the rotating body 12 is disposed on the right side.

In addition, the rotating body 2 is disposed to be tilted slightly counterclockwise from the state parallel to the XZ plane as viewed from the front of the Z-axis, and the rotating body 12 is disposed to be tilted slightly clockwise. The right end of the rotating body 2 and the left end of the rotating body 12 face each other with a gap therebetween.

The rotating body 12 corresponds to one embodiment of a second member different from the first member according to the present technology.

In this embodiment, the rotating bodies 2 and 12 rotate in the opposite directions. Specifically, as viewed from the surfaces of the rotating bodies 2 and 12 (from the surfaces where shaft members are not located), the rotating body 2 rotates counterclockwise, and the rotating body 12 rotates clockwise. FIG. 3 shows the rotation directions by the arrows.

The energy beam EB1 of the first focusing density is applied to a region 13 located on the side surface 7 of the rotating body 2 from the upper right toward the lower left in the figure. The region 13 is a region located substantially near the right end of the side surface 7, and the plasma raw material 101 adheres to the region 13 to have a predetermined film thickness.

The region 13 corresponds to one embodiment of a first region according to the present technology.

The film thickness of the region 13 corresponds to one embodiment of a first film thickness according to the present technology.

Further, an energy beam EB3 of a third focusing density is applied to a region 15 located on a side surface 14 of the rotating body 12 from the upper left toward the lower right. The region 15 is a region located substantially near the left end of the side surface 14, and the plasma raw material 101 adheres to the region 15 to have a predetermined film thickness. The film thickness of the region 15 may be the same as or different from the film thickness of the region 13.

The region 15 corresponds to one embodiment of a second region according to the present technology.

The film thickness of the region 15 corresponds to one embodiment of a second film thickness according to the present technology.

The third focusing density is set as a focusing density at which the energy beam EB3 does not reach the rotating body 12 when the energy beam EB3 is applied to the region 15. The third focusing density may be the same as the first focusing density or may be different from the first focusing density. In addition, the energy beams EB1 and EB3 may be applied at the same time or may be applied at different timings.

The plasma raw material 101 diffuses by irradiation with the energy beam EB1, and a diffusion space 16 is generated. In addition, a diffusion space 17 is generated by irradiation with the energy beam EB3. FIG. 3 schematically shows the diffusion spaces 16 and 17 without patterns. Additionally, FIG. 3 schematically shows a common space 18 that is a common part (overlapping part) of the diffusion spaces 16 and 17 in a polka-dot pattern. In the common space 18, the plasma raw material 101 is more densely diffused than in the diffusion spaces 16 and 17.

In this example, the diffusion spaces 16 and 17 have the same shape, but may have different shapes.

The diffusion space 16 corresponds to one embodiment of a first space according to the present technology.

The diffusion space 17 corresponds to one embodiment of a second space according to the present technology.

The common space 18 corresponds to one embodiment of a space that is a common part according to the present technology.

Under such a condition, the energy beam EB2 of the second focusing density is applied to the common space 18. Note that FIG. 3 omits the illustration of the energy beam EB2. The energy beam EB2 is, for example, applied from the front side toward the rear side in the figure, but may also be applied from the upper side toward the lower side, for example.

The second focusing density may be a focusing density at which, if the energy beam EB2 is applied to the region 13, the energy beam EB2 does not reach the rotating body 2, and also if the energy beam EB2 is applied to the region 15, the energy beam EB2 does not reach the rotating body 12. Meanwhile, the second focusing density may be a focusing density at which the energy beam EB2 reaches the rotating body 2 or the rotating body 12. In other words, the value of the second focusing density can be larger or smaller than the values of the first focusing density and the third focusing density.

According to this example, the energy beam EB2 is applied to the common space 18 that is a space in which the plasma raw material 101 has diffused densely, which makes it possible to obtain radiation R with a higher intensity. For example, when the energy beam EB2 is applied to the single diffusion space 16 or 17 generated by the single energy beam EB1 or EB3, the amount of plasma raw material 101 ejected to the diffusion space 16 or 17 is small, and sufficient output power of the radiation R is not obtained in some cases. In such a case, the method of this example is effective.

The three energy beams EB1, EB2, and EB3 may be respectively emitted from three different beam sources 108 or may be generated by combining two or less beam sources 108 with optical systems.

The interval between the rotating bodies 2 and 12 (arrows in FIG. 3) may be adjusted as appropriate. Adjusting the interval makes it possible to change the size of the common space 18. In addition, if the interval is too large, the diffusion spaces 16 and 17 do not meet and the common space 18 is not generated. In such a case, the interval may be adjusted to be narrower. In addition, the interval may also be made very small, so that the rotating bodies 2 and 12 form an inverted V-shape.

FIG. 4 is a schematic diagram showing a variation example of the rotating body 2.

In this example, the rotating bodies 2 and 12 are configured to rotate with a common shaft member 1 as a rotation axis. Specifically, the rotating bodies 2 and 12 are disposed on the left side and the right side in the figure, respectively, parallel to the XZ plane. Further, the single shaft member 1 is disposed parallel to the Y-direction so as to penetrate the center of each of the rotating bodies 2 and 12. When the shaft member 1 rotates, each of the rotating bodies 2 and 12 rotates integrally in the same direction.

The energy beam EB1 is applied to an upper part of a right surface 21 of the rotating body 2 from the upper right toward the lower left in the figure. In addition, the energy beam EB3 is applied to an upper part of a left surface 22 of the rotating body 12 from the upper left toward the lower right in the figure. In those parts, diffusion spaces 16 and 17 are generated respectively, and the energy beam EB2 is applied to a common space 18. Note that FIG. 4 omits the illustration of the diffusion spaces 16 and 17, the common space 18, and the energy beam EB2. In the following figures as well, the illustration of them may be omitted.

In this example, the single shaft member 1 and the single motor 4 can rotate the two rotating bodies 2 and 12, which makes it possible to achieve a configuration using the rotating bodies 2 and 12 with an even simpler configuration.

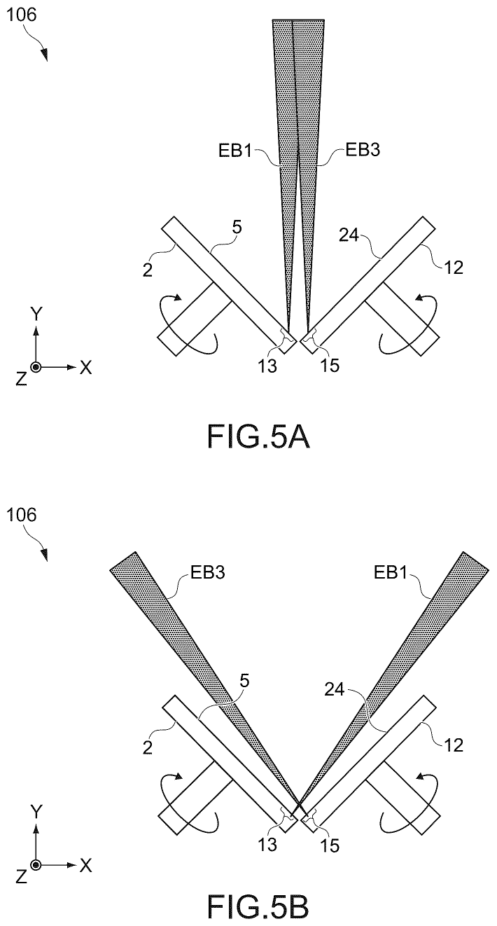

FIGS. 5A and 5B are schematic diagrams each showing a variation example of the rotating body 2.

In this example, the rotating bodies 2 and 12 are disposed to form a V shape. In addition, the rotating body 2 rotates clockwise as viewed from the side of the front surface 5, and the rotating body 12 rotates counterclockwise as viewed from the side of a front surface 24. The energy beam EB1 is applied to the vicinity of the right end of the front surface 5 of the rotating body 2, and the energy beam EB3 is applied to the vicinity of the left end of the front surface 24 of the rotating body 12.

In FIG. 5A, both the energy beams EB1 and EB3 are applied from the upper side in the figure. On the other hand, in FIG. 5B, the energy beam EB1 is applied from the upper right to the lower left, and the energy beam EB3 is applied from the upper left to the lower right. The energy beam EB2 is then applied to the common space 18, and the radiation R emitted from the common space 18 to the lower side in the figure is focused.

Providing the arrangement as in this example makes it possible to reduce the amount of debris emitted from the common space 18 to the lower side in the figure. For example, if some debris may be allowed to be emitted to the upper side but prevented from being emitted to the lower side, such a configuration is used.

In the variations of FIGS. 4, 5A, and 5B, the region 13 irradiated with the energy beam EB1 is located on the front surface 21 or 5 of the rotating body 2. In addition, the region 15 irradiated with the energy beam EB3 is located on the front surface 22 or 24 of the rotating body 12. Meanwhile, in the variation of FIG. 3, the region 13 is located on the side surface 7 of the rotating body 2, and the region 15 is located on the side surface 14 of the rotating body 12.

In addition, in the variations of FIGS. 3, 4, and 5B, the energy beams EB1 and EB3 intersect with each other. Meanwhile, in the variation of FIG. 5A, the energy beams EB1 and EB3 do not intersect with each other.

Depending on the arrangement of the rotating bodies 2 and 12 and other mechanisms, the irradiation positions I and irradiation angles of the energy beams EB1 and EB3 may be limited. In addition, in order to generate the common space 18 at a desired position, the irradiation positions I have to be adjusted in some cases. In the present technology, it is possible to apply the energy beams EB1 and EB3 to either the front surface or the side surface, and it is also possible to select whether or not the energy beams EB1 and EB3 intersect with each other. This makes it possible to take a suitable configuration depending on various situations.

Also in the case of using only the single rotating body 2, the energy beam EB1 may be similarly applied to the side surface 7. Alternatively, the energy beam EB1 may be applied to the back surface 6 of the rotating body 2. In addition, the specific arrangement of the rotating bodies 2 and 12 is not limited. Additionally, three or more rotating bodies may be disposed and may be irradiated with a total of three or more energy beams EB, respectively.

### OTHER EMBODIMENTS

The present invention is not limited to the embodiments described above, and various other embodiments can be achieved.

### [Conditions of Energy Beam EB2]

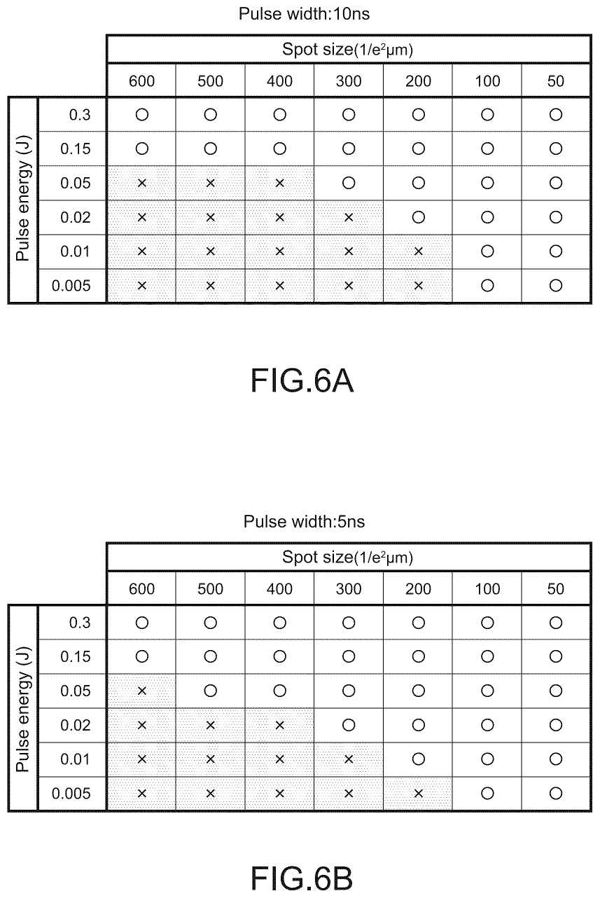

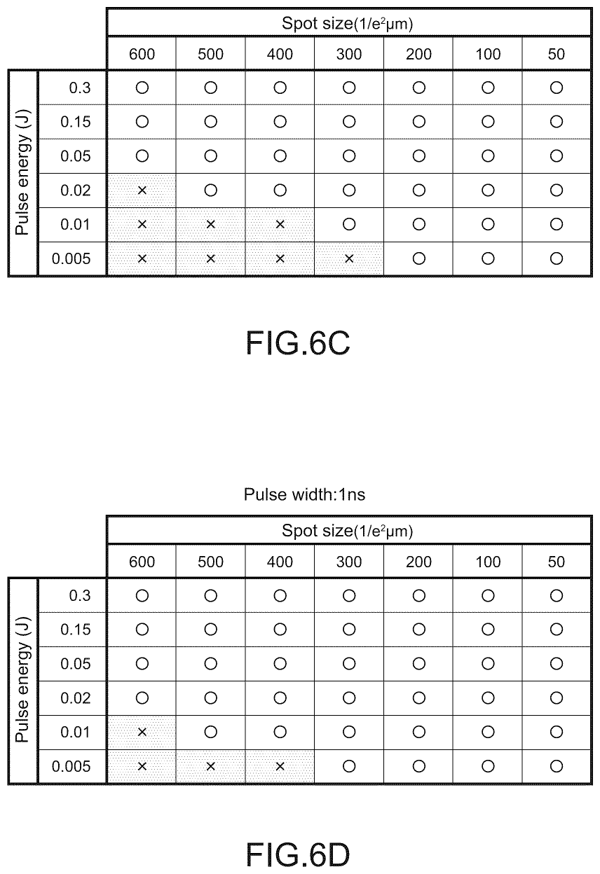

FIGS. 6A, 6B, 6C, and 6D are tables showing the conditions of the energy beam EB2.

FIG. 6A shows whether or not the plasma P that can provide a sufficient light-emitting intensity is generated when the energy beam EB2 has a pulse width of 10 ns. The row component of the table is the pulse energy (J) of the energy beam EB2, and the column component of the table is the spot size (μm). Here, the spot size is a diameter of the energy beam EB2 at a portion at which the intensity thereof is 1/e² times a peak value. Note that e is the natural logarithm and the energy beam EB2 is assumed to be a Gaussian beam.

In each cell in the table, “o” is marked if the plasma P that can provide a sufficient light-emitting intensity is generated by the irradiation with the energy beam EB2, and “x” is marked if it is not generated. As an example, if “the pulse width is 10 ns, the pulse energy is 0.05 J, and the spot size is 300 μm”, the plasma P that can provide a sufficient light-emitting intensity is generated.

Similar tables are shown respectively in FIG. 6B in which the pulse width of the energy beam EB2 is 5 ns, in FIG. 6C in which the pulse width is 2 ns, and in FIG. 6D in which the pulse width is 1 ns. As the pulse width of the energy beam EB2 becomes shorter, as the pulse energy becomes larger, or as the spot size becomes smaller, the irradiation intensity becomes higher, that is, the plasma P that can provide a sufficient light-emitting intensity is more likely to be generated.

In any one of FIGS. 6A to 6D, “∘” is marked in: a cell in which the pulse energy is 0.005 J or more and less than 0.02 J, and the spot size is 100 μm or less; a cell in which the pulse energy is 0.02 J or more and less than 0.05 J, and the spot size is 200 μm or less; a cell in which the pulse energy is 0.05 J or more and less than 0.15 J, and the spot size is 300 μm or less; and a cell in which the pulse energy is 0.15 J or more, and the spot size is 600 μm or less. In other words, if the pulse width of the energy beam EB2 is 10 ns or less, the pulse energy is 0.005 J or more, and those conditions described above are satisfied, the plasma P that can provide a sufficient light-emitting intensity is generated.

In addition, in any one of FIGS. 6A to 6D, “o” is marked in each cell in which the pulse energy is 0.15 J or more. In other words, if the pulse width of the energy beam EB2 is 10 ns or less, the pulse energy is 0.15 J or more, and the spot size is 600 μm or less, the plasma P that can provide a sufficient light-emitting intensity is generated.

Additionally, in any one of FIGS. 6A to 6D, “o” is marked in each cell in which the spot size is 100 μm or less. In other words, if the pulse width is 10 ns or less, the pulse energy is 0.005 J or more, and the spot size is 100 μm or less, the plasma P that can provide a sufficient light-emitting intensity is generated.

### [Shape Etc. of Rotating Body]

The specific shape of the rotating body 2 is not limited, and a shape other than the disk shape may be included. In addition, a member corresponding to the rotating body 2 may be a member that does not rotate. For example, the following situation may be achieved, in which the above member has a plate-like shape, and the lower part of the member is not immersed into the plasma raw material 101 but provided with the liquid plasma raw material 101 streaming thereon from above, so that the plasma raw material 101 adheres to the surface of the member with a predetermined film thickness.

On the other hand, in this embodiment, the rotating body 2 is used as the member, which makes it possible to cause the plasma raw material 101 to stably adhere thereto. In addition, the rotating body 2 has a disk shape, so that the rotation operation is stabilized.

Additionally, debris may be prevented from being scattered to the outside by covering the rotating body 2 with a cover structure. In this case, for example, an enough space for the diffusion space 10 to exist is provided between the rotating body 2 and the cover structure.

### [Irradiation on Different Regions of Same Member]

In the examples shown in FIG. 3 and the like, the regions 13 and 15 irradiated with the energy beams EB1 and EB3 are located on the different rotating bodies 2 and 12, respectively. However, the present invention is not limited to this, and the two different regions may be located on the same member.

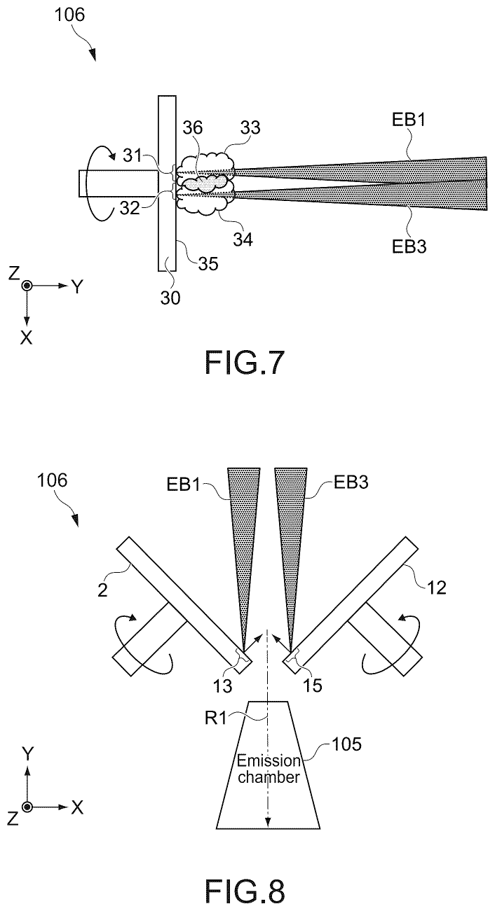

FIG. 7 is a schematic diagram showing a configuration example in which a single rotating body 30 includes two regions 31 and 32. Note that FIG. 7 is a diagram showing the rotating body 30 as viewed from the front in the Z-direction, unlike FIGS. 2A and 2B.

In this example, the energy beam EB1 is applied to the region 31 of the rotating body 30, and a diffusion space 33 is generated. In addition, the energy beam EB3 is applied to the region 32, and a diffusion space 34 is generated. The regions 31 and 32 are both located on the circumference of a front surface 35 of the rotating body 30. In other words, in FIG. 7, the regions 31 and 32 are located on the near side of the front surface 35 in the plane of the figure.

A common space 36 that is a space in which the regions 31 and 32 overlap with each other is irradiated with the energy beam EB2 (not shown) from the near side in the plane of the figure. As in this example, applying the energy beams EB1 and EB3 to the different regions 31 and 32 of the single rotating body 30 makes it possible to obtain high-intensity radiation R with a simple configuration.

Note that in this example as well, the first focusing density of the energy beam EB1 and the third focusing density of the energy beam EB3 may be the same as or different from each other. In addition, the shape of the member corresponding to the rotating body 2 is also not limited.

### [Debris Mitigation Mechanism]

FIG. 8 is a schematic diagram showing a configuration example in which the rotating body 2 disposed as a first member and the rotating body 12 disposed as a second member function as a debris mitigation mechanism.

FIG. 8 schematically shows the emission chamber 105 of FIG. 1.

In this example, a certain gap is provided between the two rotating bodies 2 and 12. When the energy beam EB2 is applied to the common space 18 (both not shown), the radiation R passes through the gap to be emitted toward the lower side in the figure.

In this state, the region 13 of the rotating body 2 and the region 15 of the rotating body 12 do not face the emission chamber 105. In other words, the orientation of the normal of the region 13 (toward upper right) and the orientation of the normal of the region 15 (toward upper left) are both tilted by 90° or more with respect to the orientation of the emission axis R1 (downward). FIG. 8 shows each orientation by an arrow.

In this embodiment, debris is generated by the irradiation with the energy beams EB1 to EB3. Of the debris, debris toward the lower side in figure is restrained to some extent by the rotating bodies 2 and 12. Therefore, for example, it is possible to reduce the influence of the debris on the members located on the lower side in the figure, such as the emission chamber 105. In other words, the rotating bodies 2 and 12 function as a debris mitigation mechanism.

Note that a similar configuration may be adopted even when only the first member is disposed, that is, only the single rotating body 2 is disposed. In other words, for example, a configuration in which no rotating body 12 nor energy beam EB3 are used may be adopted in FIG. 8. In this case as well, the region 13 does not face the emission chamber 105. In addition, scattering of the debris to the lower left side in the figure is reduced by the rotating body 2. Any other configurations in which the emission chamber 105 is disposed on the emission axis R1 and the region 13 does not face the emission chamber 105 may be adopted. In addition, in this example, the first member or second member does not have to be the rotating body, and the shape of the member is not limited.

### [Preheating]

After the diffusion space 10 is generated, the diffused plasma raw material 101 may be preheated by being irradiated with an energy beam EB of a low focusing density, and irradiation with the energy beam EB2 may be performed in the preheated state. This makes it possible to further increase the output power of the radiation R.

Among the characteristic portions according to the present technology described above, at least two of the characteristic portions can also be combined. In other words, the various characteristic portions described in each embodiment may be discretionally combined regardless of the embodiments. Further, the various effects described above are merely illustrative and not restrictive, and other effects may be exerted.

It should be understood by those skilled in the art that various modifications, combinations, sub-combinations and alterations may occur depending on design requirements and other factors insofar as they are within the scope of the appended claims or the equivalents thereof.

What is claimed is:

1. A light source apparatus that converts a liquid raw material into plasma and extracts radiation by using irradiation with an energy beam, the light source apparatus comprising:
a first member that includes a first region to which the liquid raw material has adhered with a first film thickness; and
a beam source that irradiates the first region with the energy beam at a first focusing density and irradiates a first space with the energy beam at a second focusing density, the first space being a space in which the liquid raw material is diffused by the irradiation with the energy beam at the first focusing density,
the first focusing density being a focusing density at which the energy beam does not reach the first member when the first region is irradiated with the energy beam.

2. The light source apparatus according to claim 1, wherein
the beam source
irradiates a second region, to which the liquid raw material has adhered with a second film thickness, with the energy beam at a third focusing density, the second region being different from the first region, and
irradiates a space that is a common part of the first space and a second space with the energy beam at the second focusing density, the second space being a space in which the liquid raw material is diffused by the irradiation with the energy beam at the third focusing density, and
the third focusing density is a focusing density at which the energy beam does not reach a second member when the second region is irradiated with the energy beam.

3. The light source apparatus according to claim 2, further comprising
the second member that is different from the first member and includes the second region.

4. The light source apparatus according to claim 1, wherein
the first member is a disk-shaped rotating body.

5. The light source apparatus according to claim 3, wherein
the first member and the second member are disk-shaped rotating bodies.

6. The light source apparatus according to claim 5, wherein
the first region is located on a circular surface of the first member, and
the second region is located on a circular surface of the second member.

7. The light source apparatus according to claim 5, wherein
the first region is located on a side surface of the first member, and
the second region is located on a side surface of the second member.

8. The light source apparatus according to claim 3, wherein
the beam source emits the energy beam of the first focusing density and the energy beam of the third focusing density such that the energy beam of the first focusing density and the energy beam of the third focusing density intersect with each other.

9. The light source apparatus according to claim 3, wherein
the beam source emits the energy beam of the first focusing density and the energy beam of the third focusing density such that the energy beam of the first focusing density and the energy beam of the third focusing density do not intersect with each other.

10. The light source apparatus according to claim 5, wherein
each of the first member and the second member is capable of rotating with a common shaft member being used as a rotation axis.

11. The light source apparatus according to claim 1, wherein
the beam source applies each of the energy beam of the first focusing density and the energy beam of the second focusing density as a pulse wave, and alternately applies the energy beam of the first focusing density and the energy beam of the second focusing density one time each.

12. The light source apparatus according to claim 11, wherein
the energy beam applied at the second focusing density has a pulse width of 10 ns or less and has a pulse energy of 0.005 J or more, and
if the pulse energy is 0.005 J or more and less than 0.02 J, a spot size that is a diameter of a portion at which an intensity of the energy beam is 1/e² times a peak value is 100 μm or less when e is assumed to be a natural logarithm,
if the pulse energy is 0.02 J or more and less than 0.05 J, the spot size is 200 μm or less,
if the pulse energy is 0.05 J or more and less than 0.15 J, the spot size is 300 μm or less, and
if the pulse energy is 0.15 J or more, the spot size is 600 μm or less.

13. The light source apparatus according to claim 12, wherein
the energy beam applied at the second focusing density has a pulse width of 10 ns or less and has a pulse energy of 0.15 J or more, and the spot size is 600 μm or less, or
the energy beam applied at the second focusing density has a pulse width of 10 ns or less and has a pulse energy of 0.005 J or more, and the spot size is 100 μm or less.

14. The light source apparatus according to claim 1, further comprising
an emission chamber disposed on an emission axis of the radiation, wherein
the first member is disposed such that the first region does not face the emission chamber.
